(19) United States
(12) Patent Application Publication
(10) Pub. No.: US 2026/0175080 A1
(43) Pub. Date: Jun. 25, 2026

(54) MOBILE-OPTIMIZED MOTION ANALYSIS SYSTEM FOR ATHLETES USING COMPUTER VISION & GENERATIVE AI

(71) Applicant: Greenside AI, Inc., Boston, MA (US)

(72) Inventors: David Hodge, Boston, MA (US); Jack Robinson, San Francisco, CA (US); Joshua Fagan, Charlottesville, VA (US)

(21) Appl. No.: 19/429,325

(22) Filed: Dec. 22, 2025

Related U.S. Application Data
(60) Provisional application No. 63/737,988, filed on Dec. 23, 2024.

(51) Int. Cl. A63B 24/00; A63B 69/36; A63B 71/06; G06T 7/174; G06T 7/70; G06V 10/26; G06V 40/10; G06V 40/20

(52) U.S. Cl. CPC A63B 24/0006; A63B 69/36; A63B 71/0622; G06T 7/174; G06T 7/70; G06V 10/26; G06V 40/10; G06V 40/23; A63B 2220/806; G06T 2207/30196; G06T 2207/30221

(57) ABSTRACT

A method performed by a two-dimensional video swing analysis system, comprising: continuously capturing a video of a swing session via a camera; identifying one or more swing occurrences based on one or more motion characteristics; for each of the one or more swing occurrences: retaining a portion of frames preceding and following the swing occurrence; assembling the retained portion of frames and one or more frames during the swing occurrence as a clip; splicing the clip into a plurality of image frames; determining the most likely swing position in plurality of image frames; determining key swing position data based on the most likely swing position; and producing a rating for one or more elements of the swing occurrence based on the key swing position data.

### CROSS REFERENCE TO RELATED APPLICATIONS

This application claims priority from U.S. Provisional Patent No. 63,737,988, filed on Dec. 23, 2024.

### TECHNICAL FIELD

The present disclosure generally relates to systems and methods for two-dimensional video and image swing analysis.

### BACKGROUND

There are many people who play swing sports that want to improve. Often, athletes find that they must procure expensive one-to-one instruction to make any improvements, which still has varying levels of success, try varying swing changes and hope one of the changes improves the swing, pursue self-guided instruction, or other expensive, time-consuming, and inconsistent methods.

### SUMMARY

One version under the present disclosure comprises a method performed by a two-dimensional video swing analysis system, comprising: continuously capturing a video of a swing session via a camera; identifying one or more swing occurrences based on one or more motion characteristics; for each of the one or more swing occurrences: retaining a portion of frames preceding and following the swing occurrence; assembling the retained portion of frames and one or more frames during the swing occurrence as a clip; splicing the clip into a plurality of image frames; determining the most likely swing position in plurality of image frames; determining key swing position data based on the most likely swing position; and producing a rating for one or more elements of the swing occurrence based on the key swing position data.

Another version under the present disclosure is a two-dimensional video swing analysis system, comprising: a processor; and a memory storing instructions whereby the processor is configured to perform the steps of: continuously capture a video of a swing session via a camera; identify one or more swing occurrences based on one or more motion characteristics; for each of the one or more swing occurrences: retain a portion of frames preceding and following the swing occurrence; assemble the retained portion of frames and one or more frames during the swing occurrence as a clip; splice the clip into a plurality of image frames; determine the most likely swing position in plurality of image frames; determine key swing position data based on the most likely swing position; and produce a rating for one or more elements of the swing occurrence based on the key swing position data.

Another version under the present disclosure is a two-dimensional video swing analysis system, comprising: a processor; and a memory storing instructions whereby the processor is configured to perform the steps of: receive, from a user, one or more videos of a swing occurrence; splice the one or more videos into one or more image frames; determine the most likely swing position in the one or more image frames; determine key swing position data based on the most likely swing position; and produce a rating for one or more elements of the swing occurrence based on the key swing position data.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates one version of a two-dimensional video swing analysis system under the present disclosure;

FIG. 2 illustrates one version of a method for two-dimensional video swing analysis for pre-recorded videos under the present disclosure;

FIG. 3 illustrates one version of a method for two-dimensional video swing analysis for live video recordings under the present disclosure;

FIG. 4 illustrates an example method for real-time continuous capture and swing analysis;

FIG. 5 illustrates an example method for image frame processing under the present disclosure;

FIG. 6 illustrates an example method for post-processing of image frames under the present disclosure;

FIGS. 7A, 7B, and 7C show an example user interface for a two-dimensional video swing analysis system under the present disclosure;

FIG. 8 illustrates a possible method version under the present disclosure;

FIG. 9 illustrates a possible user interface version under the present disclosure;

FIG. 10 illustrates a possible user interface version under the present disclosure;

FIG. 11 illustrates a possible user interface version under the present disclosure;

FIG. 12 illustrates a possible user interface version under the present disclosure;

FIG. 13 illustrates a possible user interface version under the present disclosure;

FIG. 14 illustrates a possible user interface version under the present disclosure;

FIG. 15 illustrates a possible user interface version under the present disclosure;

FIG. 16 illustrates possible versions of training and inference pipelines;

FIG. 17 illustrates a possible neural network version with hidden and visible layers under the present disclosure; and

FIG. 18 illustrates possible versions of various computing devices under the present disclosure.

### DETAILED DESCRIPTION

Before describing various versions of the present disclosure in detail, it is to be understood that this disclosure is not limited to the parameters of the particularly exemplified systems, methods, apparatus, products, processes, and/or kits, which may, of course, vary. Thus, while certain versions of the present disclosure will be described in detail, with reference to specific configurations, parameters, components, elements, etc., the descriptions are illustrative and are not to be construed as limiting the scope of the claimed versions. In addition, the terminology used herein is for the purpose of describing the versions and is not necessarily intended to limit the scope of the claimed versions.

There currently exist certain challenges in athletic training industries, including “swing” sports, like tennis, golf, and/or other sports. When players want to improve or learn the sport, few options exist. Often players pay for expensive lessons from golf pros to improve, play frequently with hopes of improving, try varying swing changes and hope one of the changes improves the swing, or other expensive and time-consuming methods. Current video-based swing analysis tools lack the ability to break swings into finite pieces for individual analysis and/or incorporate machine-learning capabilities. Current solutions also lack the ability to incorporate robust solutions into modular systems, such as smartphones or tablets, sometimes due to the limited computing power of mobile devices. These options often make learning inaccessible to new players and/or more casual players. Paying for lessons can be incredibly expensive with limited return on single lessons. Other than lessons, the options are limited to the knowledge of the players themselves. All these challenges can make it incredibly difficult to improve in sports like golf, baseball, tennis, and others.

Certain aspects of the versions disclosed herein provide solutions to these or other challenges. Certain versions include various functionalities. Certain versions include a two-dimensional video swing analysis system. Certain versions include a method for two-dimensional video swing analysis for pre-recorded videos. Certain versions include a method for two-dimensional video swing analysis for continuous video recordings. Other versions comprise systems and methods for two-dimensional video swing analysis.

Certain versions may provide one or more of the following technical advantages. Versions can achieve greater accessibility to players by providing swing analysis through video and image analysis, machine learning, and/or processing techniques particular to swing sports. In addition, versions can be more modular and portable than previous solutions, which often require numerous and complicated cameras, computer, video and swing systems, and/or monitors in order to analyze athletic movements and provide feedback.

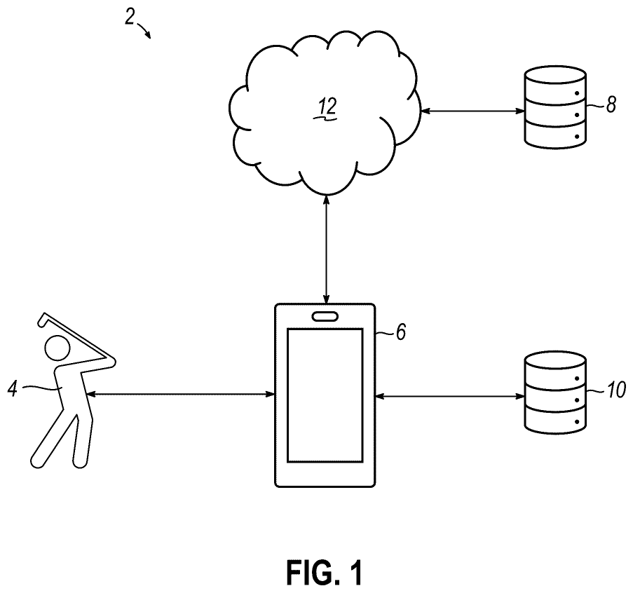

Referring now to FIG. 1, one version of a two-dimensional video swing analysis system 002 is shown. Such systems shall simply be referred to as swing analysis systems for purposes of the present disclosure. User 004 can record a swing video using computing device 006 (e.g., computers, tablets, mobile devices, etc.). A swing video may include a video of a user swinging once or multiple times or one or more individual images of a user's swing. Computing device 006 can send the swing video directly to a local memory 010. This can allow the swing analysis system 002 to run offline. This may be valuable in situations where user 004 is playing or practicing in a location without access to a network like network 012 (e.g., Internet, cellular, Bluetooth™, Wi-Fi, satellite, enterprise, private network, similar networks, or combinations of the foregoing). Computing device 006 may send the swing video via network 012 to server 008. Server 008 can send and receive data via network 012 from computing device 006. Server 008 (or computing device 006 or local memory 010) may house a video processing system, an image processing system, a swing analysis system, data management system, artificial intelligence/machine learning (AI/ML) functionalities, and/or other components for purposes of communicating with other components of FIG. 1. An AI/ML engine may be stored or operated at computing device 006, server 008, or other locations within swing analysis system 002. Server 012 and/or computing devices 006 may comprise an AI/ML engine(s). AI/ML engines may comprise or perform AI/ML functionality as described further herein.

Several functionalities offered by e.g., swing analysis system 002 include: two-dimensional swing analysis, image frame processing, AI/ML swing analysis, continuous analysis, continuous video capture and analysis, and/or post-processing of image frames.

Two-dimensional swing analysis: server 008 can send information about a swing analysis process to computing device 006 via network 012. This can be done as part of the swing analysis or can be completed prior to initializing a swing analysis. If this communication is done prior to initializing a swing analysis, computing device 006 can download instructions for a swing analysis such that one or more swing analyses can be completed offline. The instructions may be stored in local memory 010. If the computing device 006 can access network 012 when a swing analysis is requested, the computing device 006 can communicate through network 012 with server 008. User 004 can take an image or video of one or more swings on computing device 006. User 004 can then upload the swing image or video for swing analysis. Swing analysis may include pose estimation, determining which image frames represent which swing position, aggregating the image frames, determining ratings for positions, reporting results to the user 004, and/or other processes.

Image frame processing: server 008 and/or computing device 006 can receive a swing video. Server 008 and/or computing device 006 can then split the swing video into image frames. Server 008 and/or computing device 006 may then process the image frames individually, or simultaneously, such that computing device 006 can complete the process without overloading local memory 010 if running offline. This may be done by processing the image frames with asynchronous analysis functions.

AI/ML swing analysis: Server 008 and/or computing device 006 can receive a swing video from local memory 010 or from network 012. Server 008 and/or computing device 006 can then process image frames from the swing video such that the image frames are formatted consistently. Server 008 and/or computing device 006 can then use AI/ML to analyze the user's swing in the image frames. AI/ML may include a pose estimation model, swing detector model, swing position classifier, rating model, club detector, and/or other relevant model. A pose estimation model can take an image as input and produce coordinates of where a human body exists within the image as output.

In some versions, analysis may include processing left-handed and right-handed swings consistently by first determining handedness from user profile data and/or from cues in early frames (e.g., grip orientation, club alignment, etc.). Left-handed inputs may be mirrored horizontally during preprocessing so semantic roles such as “trail” and “lead” may map onto a standard coordinate system. In some versions, feeding the original frames to models trained on mixed handedness with an explicit handedness input may be used so the classifier can interpret side-specific asymmetries without transformation. This process may preserve a handedness flag in metadata for display, reporting, and/or instructional phrasing so outputs use the correct terms for the user. This may also ensure laterality normalization occurs prior to pose normalization and/or thresholding so ratings and/or position detection can operate on a consistent definition of body sides. This may further avoid drift and/or mismatches in measured angles or distances.

A swing detector model may predict where in a swing video one or more swings, or portions of swings, occur. A swing may include golf swing, tennis swing, baseball swing, or other any other swing. The swing detector model may determine which frames of a swing video contain a backswing, downswing, or neither. This can allow the model to search for sequences of backswings or downswings such that the model can determine whether a swing has occurred. The swing detector model may include a convolution neural network (CNN), ReLU activation, dropout, softmax functions, or other elements.

In some versions, a swing detector may detect practice swings as well as swings and non-swings. Detected swing segments may undergo a validation phase that may classify each segment as a practice swing or a scored swing by computing features from pose trajectories, club tracking signals, and/or other elements. These features may then be evaluated based on predetermined rules and/or an AI/ML classifier. Peak club-head speed may be extracted from shaft-tip coordinates across time using temporal smoothing filters to suppress motion noise. The timing of lower-body initiation may be derived by measuring the onset of hip rotation relative to an initial hand motion. When available, impact indicators such as ball flight detection and/or audio amplitude spikes may be aligned to frame timestamps to corroborate the presence of a struck ball. These features may feed a probabilistic scorer that may output a practice probability, which may be compared against a threshold which may be configurable by a user profile and/or skill level. Segments exceeding the threshold may be discarded from as practice and/or session analytics as practice but may be logged for coaching context, whereas segments below the threshold may be passed to rating and feedback generation modules. To prevent bias in early sessions, the validation phase can incorporate a grace period where thresholds may adaptively tighten as more scored swings are observed for the user, and the classifier's calibration may be periodically updated using instructor-labeled examples.

A swing position classifier may predict which image frames of a swing video contain key swing positions that may be relevant to instruction or improvement. A swing position classifier may analyze images to extract coordinates of arms, legs, hips, etc. to create a “skeleton pose”, and may take coordinates of a skeleton pose as an input and output the probability of an image containing a certain swing position. A swing position classifier may include a CNN, ReLU activation, dropout, softmax functions, and/or other elements.

A rating model may assess the quality of a user's swing. This may include analyzing multiple points on the user's body. These points may be compared to a curated dataset. The curated dataset may include swing videos that can represent an ideal swing. The curated dataset may be fed to an AI/ML model that can determine thresholds for acceptable and unacceptable variations for varying points on a user's body throughout a swing. These thresholds may be used to determine the rating of a user's swing. A rating model may include a CNN, ReLU activation, dropout, softmax functions, or other elements.

In some versions, the rating model may derive thresholds and ranges from qualitative guidance collected from professional instructors that may define desired positions and/or motions in plain terms and quantitative datasets which may include recordings of professional golfers that may supply distributions for measurable variables such as joint angles, timing offsets between phases, club metrics, and/or other variables. Instructor guidance may be converted into concrete measurement targets, statistical parameters may be fit to the professional datasets, and resulting ranges may be stored by position (e.g., P1-P7), perspective, skill level, and/or other metrics. During analysis, a user's measurements may be computed and compared to the appropriate ranges. This may produce a numeric score and/or a textual explanation like “trail-arm set at P4 slightly above recommended range” or “hip turn within target band.” These thresholds may adapt to user progression by widening ranges for beginners to prevent discouraging feedback and narrowing them gradually as consistent improvements are observed. These evaluations may be recalibrated over time with new expert inputs and/or updated datasets.

A club detector model may predict bounding boxes within image frames of a swing video that may contain a club head and/or a club shaft. In some versions, club tracking may extend beyond bounding boxes by computing continuous trajectories for the shaft and/or head across frames and smoothing those trajectories so they reflect realistic motion, which may be especially useful near impact when blur is more likely to occur. A tracker may be initialized from detector outputs, may apply temporal filters to stabilize positions, and/or may constrain velocity and/or acceleration within typical swing ranges to avoid physically implausible jumps. Training and validation of the club detector module may include diverse scenarios such as bright sun, indoor lighting, reflective surfaces, partial occlusions, and/or other scenarios so the tracker can remain reliable. The resulting trajectories may produce club metrics like head speed, shaft lean, path curvature, and/or other metrics which the system may align with pose timelines and/or impact events to generate integrated ratings and/or explanations. Tracking confidence may be propagated to post-processing so low-quality signals may not unduly influence scores.

AI/ML may also be used to generate personalized feedback and/or explanations for a user based on data that may be provided by the above-mentioned AI/ML models or other data sources. The personalized feedback and/or explanations may be generated by an LLM or other model. The personalized feedback and/or explanations may include a description of the user's current swing, why certain elements of a swing matter, how certain things the user is doing are affecting the user's swing, tips on how to improve the user's swing, suggested drills or practices, suggested tools to improve the user's swing, suggested equipment, or other relevant feedback and/or explanations. In some versions, the system 002 may include one or more AI/ML models that can receive a message from a user and maintain structured or unstructured conversation with the user regarding swing improvements, tips, and/or other relevant conversation. AI/ML models may include a LLM or other model. A club detector model may include a CNN, ReLU activation, dropout, softmax functions, or other elements.

Additionally, the system may compute a comprehensive set of biomechanical measurements on every frame using two-dimensional pose geometry. These measurements may include hip rotation, hip sway, hip bend, shoulder rotation, shoulder sway, shoulder tilt, spine angle, lead knee bend, trail knee bend, weight distribution, arm hang, hip hinge, lead arm extension, trail elbow bend, hand position, trail foot position, club shaft angle in transition, and club head position in takeaway. These metrics may be used to generate ratings, detect swing flaws, and provide targeted recommendations for improvement.

Post-processing of image frames: server 008 and/or computing device 006 can receive one or more processed image frames of a swing video. Server 008 and/or computing device 006 can then sort the processed image frames by timestamp such that the processed image frames are in order from start to finish of the swing. Server 008 and/or computing device 006 may then maximize the predictions for each swing position based on the sorted image frames. Server 008 and/or computing device 006 can then aggregate the data from the individual image frames and measure the body poses from the image frames against predetermined thresholds for an ideal swing. Server 008 and/or computing device 006 may then produce a rating for each body part of the body poses. Server 008 and/or computing device 006 may then use this information to generate corresponding explanations, assessments, tips, potential areas for improvement, and/or other relevant feedback and/or explanations for the user.

One benefit of two-dimensional video swing analysis system 002 may be customized, easily accessible feedback on swings for users as well as improvement in video and image processing for use in offline environments. Further, the two-dimensional video swing analysis system 002 may also store previous swings and continuously improve any AI/ML models and generate more customized feedback and/or explanations for users over time.

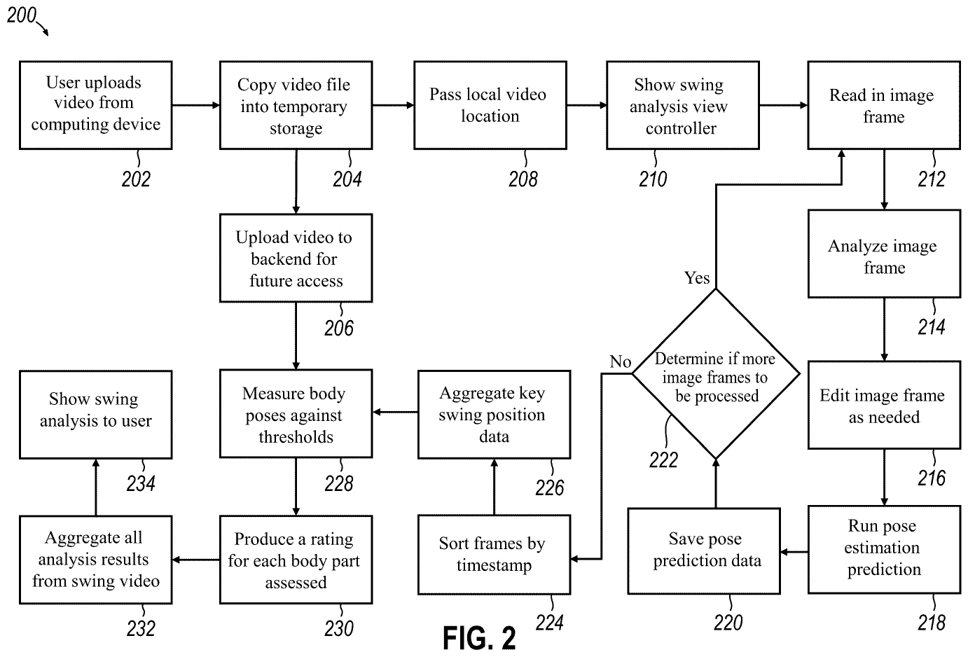

FIG. 2 illustrates one version of a method for two-dimensional video swing analysis for pre-recorded videos 200. First, a user may upload a swing video from a computing device 202. Then a processor of the computing device can copy the swing video into temporary storage 204. The swing video can then be saved for future access 206. This may include saving the video to a local memory associated with the computing device, sending the swing video via a network to a server or cloud storage, or other storage locations. After the swing video is copied into video storage 204, the local location of the swing video may be given to a swing video analysis pipeline 208. Then a view controller may update a user interface to show a loading screen, the unprocessed swing video, or another view relevant to the user 210. Then the processor can read in individual image frames from the swing video 212. This may be done such that the processor can complete the process without overloading local memory while running offline. This may include processing the image frames with asynchronous analysis functions.

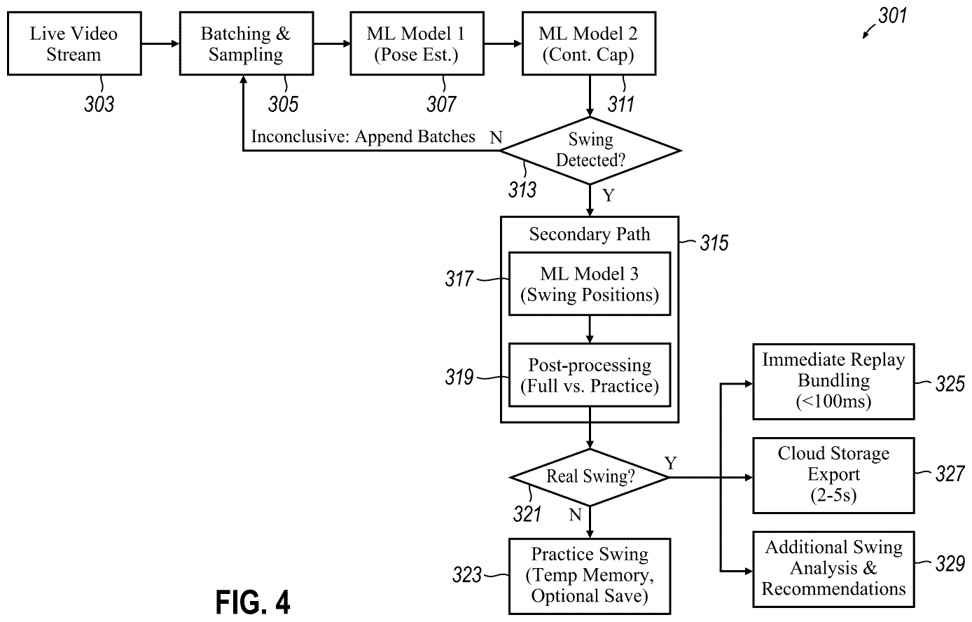

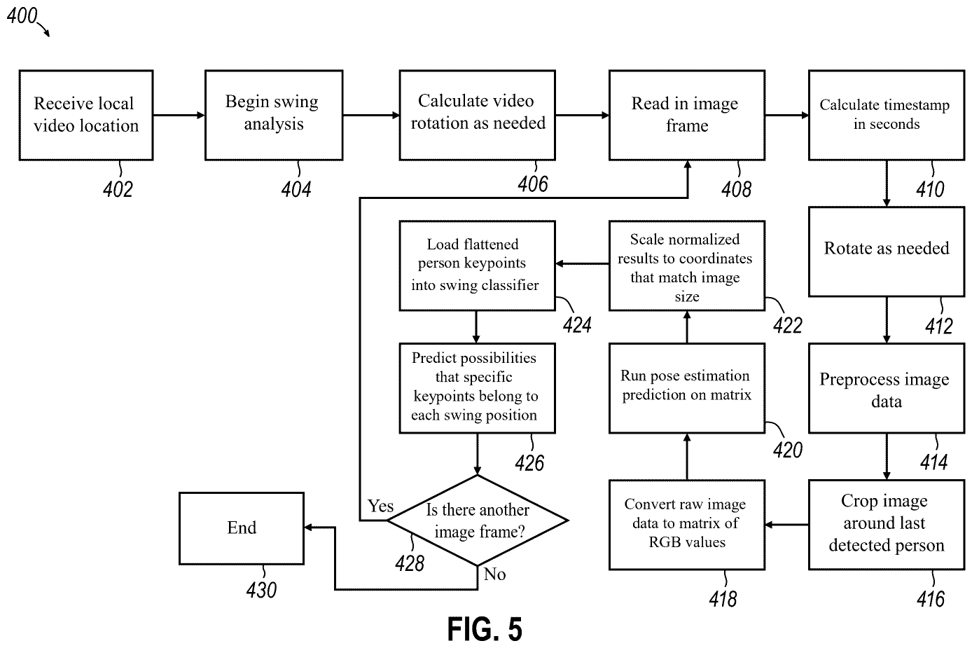

From there, the processor can analyze an image frame 214. Processing the image frame may include methods of FIGS. 4, 5, and/or 6, or other image processing methods. The processor may then determine in what ways, if any, the image frame may need to be edited such that a pose estimation can be most effective 216. Then the processor may generate a pose estimation prediction based on the image frame 218. The processor can then save the pose prediction data for the image frame 220. The pose prediction data may be saved locally or sent via a network to a server or cloud storage, or other storage locations. The processor may then determine if there are more image frames that need to be processed 222.

If more image frames need to be processed, the method reads in another image frame 212 and continues from that point. The image processing can occur asynchronously to avoid overloading local memory. Once all image frames are read in and processed, the processor can sort the image frames by the timestamp of each image frame 224 such that the image frames can be organized such that the frames together form the entirety of a swing. The processor can then determine the key swing position data from the swing position data associated with the image frames 226. This may be done by determining the best swing position image frames, using the data from the image frames with the highest probability of being a specific swing position, aggregating data for each position based on image frames most likely to be each position, and/or other aggregation methods.

Then the processor may measure the body poses for each position against predetermined ideal thresholds 228 and produce a rating for each body part assessed 230. This may include a rating model as described above or another rating model. The results of the rating model may then be aggregated as overall ratings for the swing video 232. This may include ratings for the overall swing, individual elements of the swing, an improvement score compared to previous swings, body part ratings, sub-ratings for varying swing elements, and/or other ratings. Then the swing analysis results can be presented to the user 234. The results may be shown on a user interface on the computing device, sent to multiple users, virtually shown overlaying the swing, textually, customized by inputting the results into a LLM or other language model to customize the presentation, provided as structured data to third-party applications, and/or other methods.

In some versions, the results may include a shareable package for each analyzed swing that may include an encoded video clip, pose key points and timestamps, detected positions and/or ratings, feedback text, and/or capture metadata such as session time, perspective tag, calibration values, and/or model versions. The package may be serialized to a structured format suitable for mobile and/or web clients and published via access-controlled endpoint. When an instructor or collaborator opens a shared link, the client may reconstruct overlays from key points and/or timestamps, align feedback to the video timeline, and/or display explanations in context. This process may allow recipients to download the raw data fields for offline analysis or documentation.

In some versions, an instructor portal may be provided that can load shared swing artifacts and may offer tools to annotate the video with drawings and/or overlays (lines, angles, highlights, etc.), add notes anchored to specific moments, compose structured recommendations with standardized tags tied to common swing elements, and/or otherwise provide feedback. These annotations may be saved as overlay primitives associated with timestamps and/or positions and may be synchronized back to the user's device so guidance can appear directly in playback. Instructor feedback may be stored as labeled events that can be matched to model outputs and/or post-processing decisions, which may enable the system 002 to learn which signals instructors reinforce or override. Over time, this labeled data can be used to refine rule thresholds and/or explanation wording so automated feedback may align more closely with coaching practices.

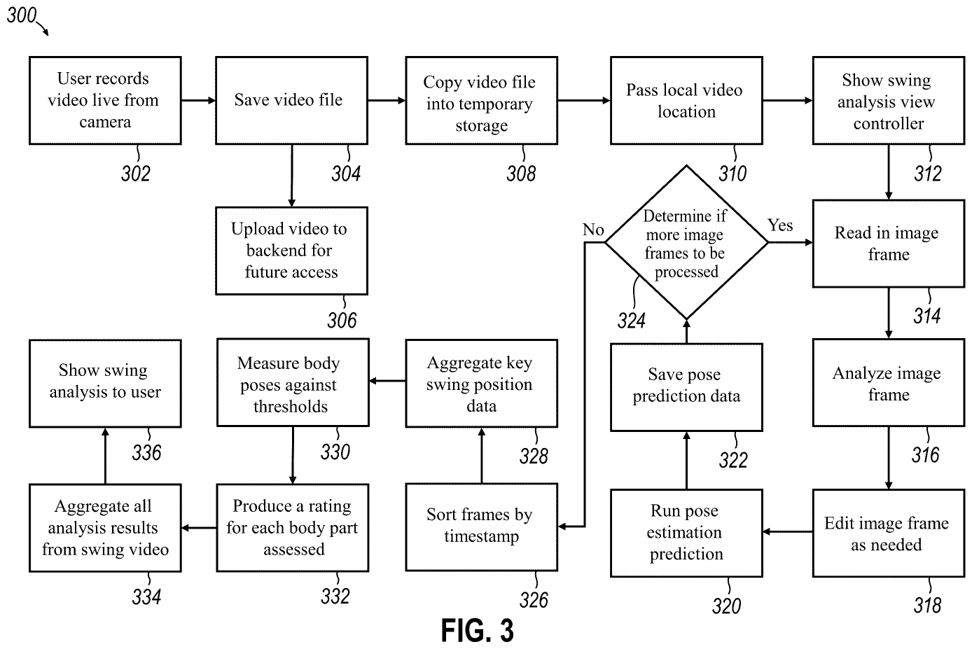

FIG. 3 illustrates one version of a method for two-dimensional video swing analysis for live video recordings 300. First, a user can record a swing video within an app on a computing device 302. A processor within the computing device can then save the swing video to a local memory associated with the computing device if running offline 304. If possible, the processor may save the swing video by sending the swing video via a network to a server or cloud storage, or other storage locations. Then the processor may be saved for future access 306. This may include saving the video to a local memory associated with the computing device, sending the swing video via a network to a server or cloud storage, or other storage locations. From there, the method may continue as the method in FIG. 2 308-336.

In some versions, real time continuous capture may be implemented using a circular video buffer resident in memory and backed by one or more platform media APIs such as AVAssetWriter or the equivalent. FIG. 4 illustrates an example method 301 for real-time continuous capture and swing analysis. The method 301 begins with a live video stream 303 captured by a camera on a computing device. Frames from the live video stream may then be ingested and passed to a batching and sampling module 305. This batching and sampling module 305 may select frames at a consistent sampling rate of about ten frames per second, about five frames per second, about fifteen frames per second, or another sampling rate, across varying capture rates (e.g., sampling every third frame for 30 frames per second (fps) or every sixth frame for 60 fps). Sampled frames may be grouped into batches for efficient processing.

The batched frames may then be first processed by a machine learning (ML) model 1 307 for pose estimation, which may generate pose key points for each sampled frame. These pose estimations may then be provided to a ML model 2 311 for continuous capture analysis, which may determine whether a swing has occurred. Then the system may determine if a swing was detected 313. The decision logic may apply minimum confidence thresholds to prevent false triggers caused by transient motion or noise. This may ensure that only sustained and high-confidence detections are treated as valid swings, which may reduce the likelihood of accidental activation during non-swing movements, particularly during continuous video capturing. If the system cannot conclusively identify a swing, additional batches may be appended until a decision can be made. This asynchronous batching approach may ensure that capture remains responsive and may avoid writing intermediate data to disk, which may reduce latency.

If a swing has occurred, the system may initiate a secondary path 315 for deeper analysis. In this path, a ML model 3 317 for swing positions analysis may classify frames into swing positions such as address, takeaway, top, downswing, impact, etc. Following classification 317, post-processing 319 may refine position boundaries, enforce proper ordering of swing positions, and/or merges or splits boundaries based on confidence trends and/or continuity across adjacent frames. Post-processing 319 may also filter out false detections caused by background movement using spatial masks and/or identity checks.

Next, the system may determine whether the detected swing is a real swing or a practice swing 321. If the swing is identified as a practice swing, the video may be retained temporarily in memory and may be optionally saved by the user 323, but may not be analyzed initially. If the swing is identified as a real swing, the system may proceed with immediate replay bundling 325, which may assemble the in-memory frames and display a video replay to the user. This may occur in under about 100 ms, about 150 ms, or another timeframe. Then a cloud storage export 327 may occur, which may write the same frames to a video asset for persistent storage within about two to about five seconds, about one to about three seconds, or another timeframe.

In parallel, the system may execute additional swing analysis and/or recommendations 329 such that biomechanical measurements and/or coaching feedback are available immediately after replay. This additional swing analysis and/or recommendations 329 may include generating ratings for one or more swing elements and/or providing personalized improvement suggestions.

Throughout the method 301, the live video streams raw frames 303 may continuously be streamed to the user interface for real-time preview while batching 305 and inference 307, 311, 317 may occur in the background. This dual-path architecture may ensure smooth capture and near real-time feedback even under load. In some versions, batch size and model precision may be adjusted dynamically based on device resources to maintain responsiveness. All processing may occur asynchronously. Pipeline backpressure may be managed by sampling adjustments while maintaining a consistent confidence threshold.

In some versions, a dual-path approach may be used to reduce latency during continuous capture. A primary path may stream raw video frames directly to the user interface with minimal processing so the user can see the recording immediately, while a secondary path may process the same frames in the background for pose estimation, swing position classification, and/or preparation of analysis results. The background path may group frames into small batches for efficient inference and may run machine learning models optimized for the device, such as CoreML models or other models. As results become available, the user interface may be updated asynchronously with overlays like key points or position labels, which may allow feedback to appear while recording continues. To maintain responsiveness, writing processed clips to storage may be delayed until analysis is complete and batch size or model precision may be adjusted when device resources are limited, which may ensure smooth preview and/or near real-time feedback even under load. In the context of FIG. 4, the ML models may be lightweight CNNs for mobile inference.

In some versions, the two-dimensional swing analysis system 002 may include session by session tracking. Session tracking may include maintaining swing data over time, maintaining data over multiple sessions, or otherwise tracking swing data. The system 002 may generate explanations regarding a user's swing based on the collected swing data to aid in user understanding of the user's specific swing. The system 002 may aggregate metrics across all swings in a session and compute trends versus the user's baseline so improvement and/or fatigue patterns can be surfaced in summaries and/or coaching plans. The analytics module may maintain time-stamped histories of key measurements (e.g., hip turn, shoulder tilt, trail-arm set, early extension, etc.) and apply rolling statistics to detect gradual changes. When meaningful deviations are found, insights may be published to a coaching module and/or progress views so recommendations may reflect session-level context. Session records may preserve calibration and perspective metadata so future comparisons and model updates can be evaluated against consistent conditions. The system 002 may also tighten or relax thresholds over time according to observed progress.

In some versions, the two-dimensional swing analysis system 002 may include using extended live video that may include multiple swings as input for swing analysis, splice each individual swing, analyze the individual swings, and/or analyze a user's overall swing success. In some versions, the two-dimensional swing analysis system 002 may rate a swing, body part, and/or other swing element as qualitative metrics. In some versions, there may be an option for a user to request advice, tips, or other information relating to how to fix a particular issue with their swing. In some versions, there may be an option for a user to see how certain ratings may improve once corrected, one or more suggested drills or corrections, analyze a user's performance over time based on saved swings, potential games to assist in improving, swing to swing comparisons, adjustments for accessibility, or other features. This system 002 may be used for rehabilitation of injuries, form for body movements, or other purposes.

This system 002 may also analyze swings from multiple angles and may use multiple cameras. The system 002 may train detection, pose, and/or position-classification models using datasets that may mix down-the-line, face-on, and/or other orientation recordings so the models can learn features that are stable across viewpoint changes. During runtime, the system 002 may determine the perspective by examining pose geometry (e.g., shoulder-line orientation, club directionality, etc.) and an estimated target line from calibration. The system 002 may then normalize key points into a common reference space using a camera-to-subject transformation which may be computed at setup. Perspective tagging may ensure measurements and explanation templates appropriate to the view are selected. For example, face-on angles may emphasize hip sway, chest rotation, and/or trail-arm abduction/adduction where frontal visibility is strongest, and down-the-line angles may emphasize shaft plane, swing path, shoulder tilt, and/or spine angle where lateral geometry is clearer. To accommodate varied camera placement, the system 002 may apply scale and/or rotation normalization to pose coordinates and may augment inputs with view descriptors so per-view thresholds remain accurate.

In some versions, before recording, a short calibration capture may be performed which may detect two-dimensional human pose key points using device vision APIs. This calibration process may estimate the camera's position and orientation with respect to a user and target line and may compute angles and offsets (e.g., yaw relative to the target line, pitch relative to the horizon, roll of the device, lateral offset, approximate height, etc.). When depth is available, the system 002 may place key points into a three-dimensional skeleton to further improve estimation accuracy. Otherwise, learned singular cues and/or geometric consistency checks may be used. The measured setup may be compared to recommended ranges for golf capture (e.g., camera height near hip level for down-the-line, a known lateral offset from the target line, etc.). Then simple on-screen guides may be rendered, and natural-language instructions may be provided such as “raise camera slightly” or “rotate a few degrees toward the target line” to aid a user in correcting any alignment and/or orientation issues. Once alignment meets a configurable score, calibration metadata (angles, offsets, view tag, etc.) may be stored and propagated to one or more analysis modules so coordinates can be normalized, and thresholds can be applied consistently throughout the session.

In some versions, the swing analysis system 002 may be integrated into simulators and/or launch monitors like golf simulators or other sports simulators. The system 002 may receive data from a simulator and/or launch monitor; assess cause and effect relationships between biomechanic data, equipment data, other data recorded by one or more simulators and/or launch monitors, and/or data recorded by the system itself; and/or otherwise analyze data provided by one or more simulators and/or launch monitors. This system 002 may also be integrated with simulation systems and/or launch monitoring systems such that the system can determine correlations between swings and the swing results.

FIG. 5 illustrates an example method for image frame processing. Image frame processing may occur throughout the methods from FIGS. 2 and 3 200, 300. Image frame processing may occur during steps 212-222 of FIG. 2 and/or steps 314-324 of FIG. 3. First, a processor may receive a local location of a swing video 402. Once received, the processor may begin a swing analysis on the particular swing video 404. The processor may then analyze the swing video to determine if the video needs to be rotated such that the video is orientated in the preferred manner 406. The processor may then splice the video into individual image frames and read in the image frames 408. This process of image frame analysis can be done with asynchronous analysis functions in sequence to prevent memory failure. The processor can then calculate the timestamp for the image frame and save that data associated with the image frame 410. The processor can then determine if the image frame needs to be rotated to better perform a swing analysis on the image frame and rotate the image frame as needed 412.

The processor may preprocess the image frame data 414. Preprocessing the image frame data may include enhancing the image frame's quality, extracting relevant information, and preparing it for further analysis. This may involve resizing, color space conversion, noise reduction, contrast adjustment, normalization to ensure consistent data format for processing, or other actions. The processor may then crop the image frame around a detected user in the image frame 416. The processor can then convert raw image frame data to a matrix of RGB values or other relevant values 418. The processor can then use the matrix of RGB values as input into a pose estimation model as described above 420. The result of the pose estimation model analysis may include coordinates of where a user exists in the image frame or other relevant data. This data may be scaled to match the image frame size such that the coordinates of the user within the image frame as easily readable and accurate 422. Then the processor can convert the coordinates to a flat array and load that array into a swing position classifier 424, as described above.

The swing position classifier may take the flat array as input and output the probability of the image frame containing a certain swing position 426. The swing position classifier may include a CNN, ReLU activation, dropout, softmax functions, or other elements. The processor may then determine if another image frame needs to be processed 428. If another image frame does need to be processed, the method repeats on the next image frame from step 410. If another image frame does not need to be processed, the image frame processing is complete 430.

In some versions, per-frame classification may be supplemented with sequence models that may consider the entire motion across phases to understand how earlier movements may impact later results. Time-aligned sequences of normalized pose coordinates, derived angles, and club orientation may be constructed and fed to a sequence model that may compute importance weights over prior frames for a metric of interest at impact or another key moment. The sequence model may output a predicted metric and/or an attention map identifying which earlier frames most influenced the prediction. The attention map may be converted into explanation metadata so feedback can say, for example, “takeaway path affected downswing angle,” and may also be used to prioritize coaching cues toward root causes rather than symptoms.

In some versions, capture, detection, segmentation, pose estimation, position classification, artifact preparation, upload, preview updates, and/or other processes may run in parallel so feedback can appear quickly without interrupting recording or other processes. Task queues and simple dependency signals may be used so each process can consume outputs as they become available. Processing intensity, such as batch size or model precision, can be adapted based on device performance and/or temperature to maintain responsiveness. Queue depth thresholds can temporarily slow upstream detection or clip assembly when analysis processes are busy, and lightweight health checks may restart stalled tasks, thereby maintaining continuous operation under variable load.

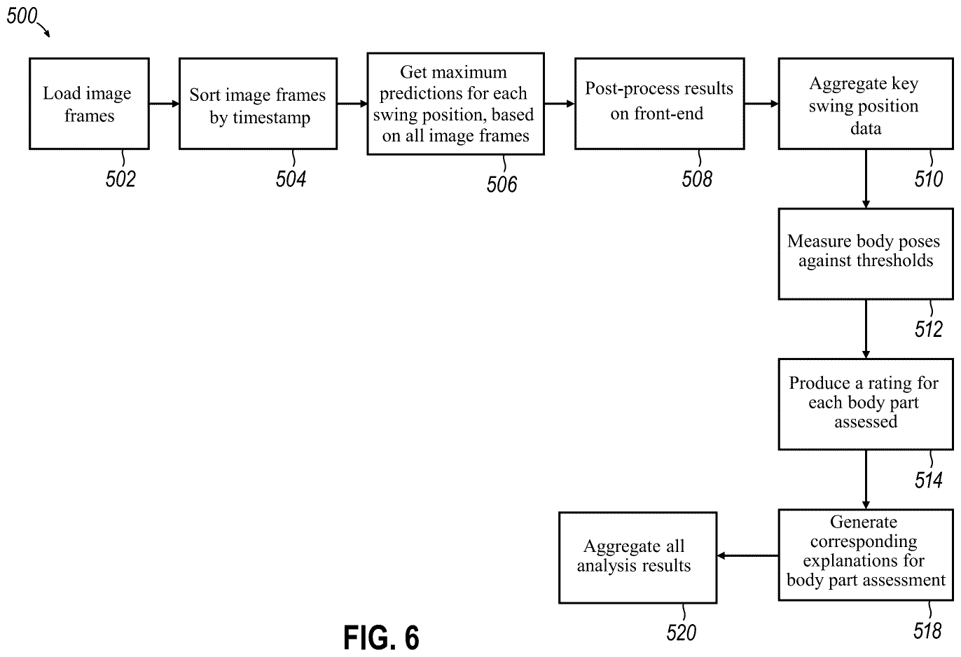

FIG. 6 illustrates an example method for post-processing of image frames. Post-processing of image frames may occur throughout the methods 200 and 300 from FIGS. 2 and 3. Post-processing of image frames may occur during steps 224-234 of FIG. 2 and/or steps 326-336 of FIG. 3.

First, a processor may load one or more image frames 502. Then the processor can sort the image frames by timestamp 504 such that the image frames can be organized such that the frames together form the entirety of a swing. Then the processor can determine the maximum predictions for each swing position based on the entirety of the image frames 506. The processor can then post-process the results 508. Post-processing may include correcting prediction quirks, correcting image frame issues, adjusting result parameters, detecting issues and correcting them, or other post-processing techniques.

In some versions, post-processing results may include correcting out-of-order swing position predictions, such as ensuring P1 comes before P2, or that P7 is between P5 and P10, or other corrections. The processor can then aggregate the key swing position data 510. Then the processor may measure the body poses for each position against predetermined ideal thresholds 512 and produce a rating for each body part assessed 514. This may include a rating model as described above or another rating model. The processor can then generate explanations that relate to swing video analysis 518. In some versions, these explanations may be generated by inputting the analysis results into a LLM or other language model to customize the explanations. In some versions, these explanations may include explanations of elements of a swing that relate to the result of the swing. The results of the rating model may then be aggregated as overall ratings for the swing video 520. This may include ratings for the overall swing, individual elements of the swing, an improvement score compared to previous swings, body part ratings, sub-ratings for varying swing elements, or other ratings.

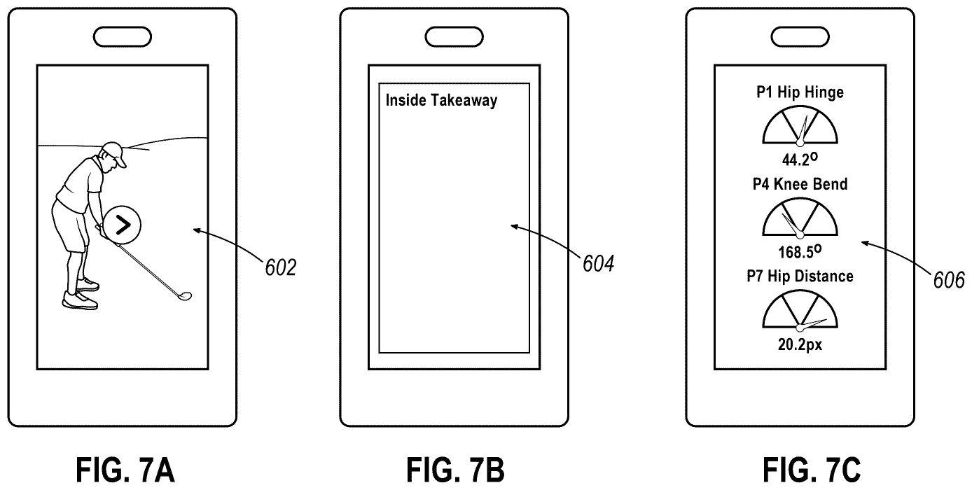

FIGS. 7A, 7B, and 7C show an example user interface for a two-dimensional video swing analysis system 002 under the present disclosure. FIG. 7A shows a possible view in a user interface that may include a swing video of a user, professional user, user's friend, or other user 602. FIG. 7B shows a possible view in a user interface that may include a description, explanation, correction, or other swing video analysis result 604. In some versions, this view may include a video, animation, image, or other medium to aid in swing correction. FIG. 7C shows a possible view in a user interface that may include ratings for varying elements, body parts, or other relevant elements 606. These user interfaces may run via a network or offline.

Pose estimation prediction may include taking the image frame as input and producing coordinates of where the human body exists in the image frame as output. Pose estimation predication may also include taking the coordinates of the human body within the image frame as input and producing a probability that the image frame contains one or more swing positions. For example, for a golf swing, the output may be the probability that the image frame contains each swing position P1 through P7, the standard golf swing positions as used by golf instructors. In other versions, the swing positions may be other positions relevant to the sport or activity. In some versions, the output may be a matrix with the probabilities of each position associated with the position name. Pose estimation prediction may include convolutional neural networks, ReLU activation, dropout, softmax functions, or other AI/ML models and/or functions.

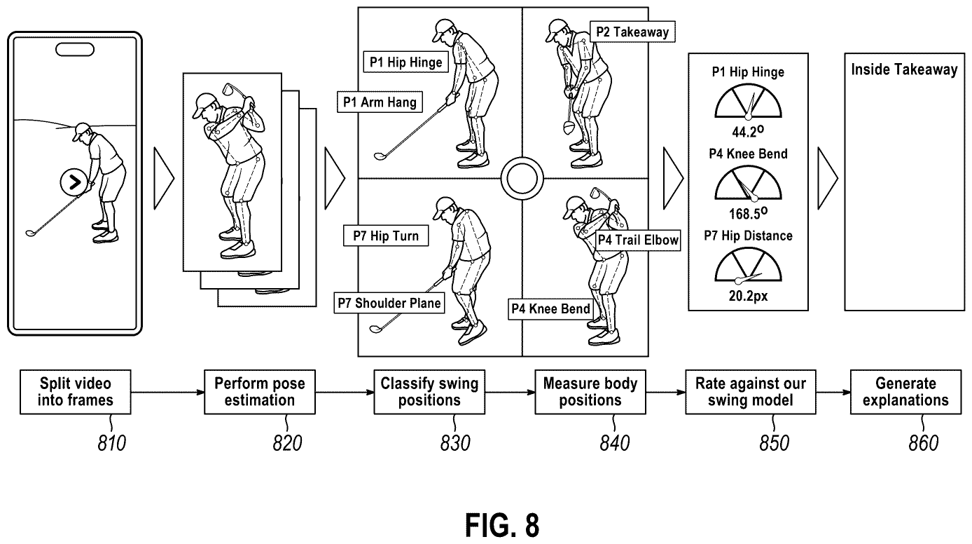

FIG. 8 illustrates one method version 800 for performing swing analysis under the present disclosure. This example is for a golf swing. But other movements are possible, such as a tennis swing, shooting a basketball, throwing a football, etc. After receiving a video (e.g., taking one with a smartphone, or receiving an uploaded video, etc.), step 810 is splitting the video into frames. Step 820 is performing pose estimation. Step 830 is classifying swing positions. Swing positions could comprise the following (though other methods of classification are possible): P1 Hip Hinge, P1 Arm Hang, P2 Takeaway, P4 Trail Elbow, P4 Knee Bend, P7 Shoulder Plane, P7 Hip Turn. As can be seen, a single image might comprise multiple swing positions, e.g., a knee position and a shoulder position. Step 840 is measuring body positions. This may involve measuring e.g., a longitudinal distance between body parts, a rotational angle between body parts, or other measurements. Step 850 is rating the swing or various swing positions against one or more swing models. Swing models could be based on industry standard measurements of what a good swing or movement looks like, based on a chosen model (e.g., the golf swing of a professional golfer, the jump shot of a professional basketball player), based on a model combining various professionals, or based on another model. Step 860 is generating explanations, such as with LLMs or generative AI, to give the user feedback. Method 800 can comprise additional, optional, and alternative steps and/or other variations. Method 800 can be performed by e.g., server 008, computing device 006, and/or local memory 010, of FIG. 1, or combinations of the foregoing. In some versions, a user may allow swing data to be provided to an instructor in order to improve lesson outcomes.

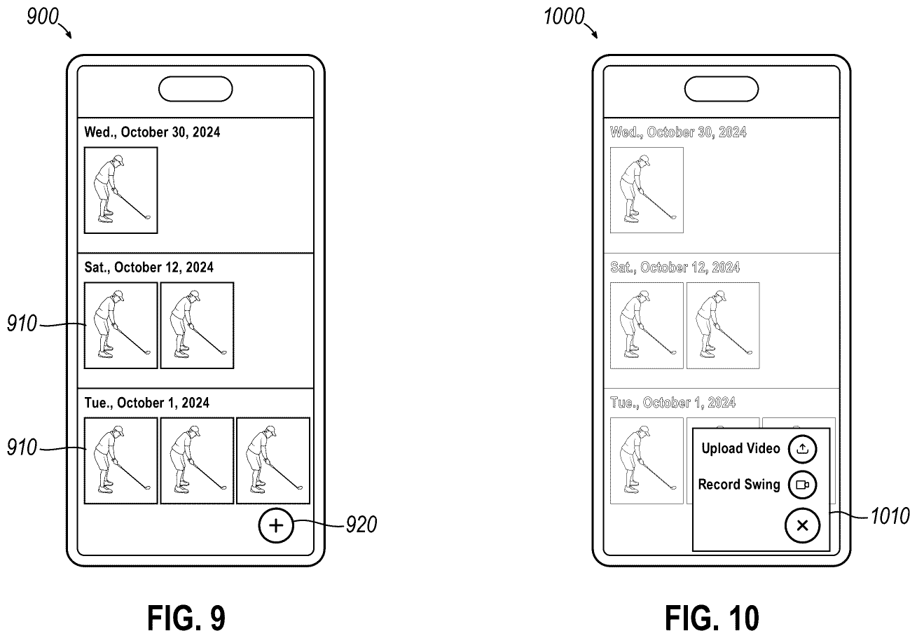

FIGS. 9-16 illustrate a variety of user interfaces that can be presented to users by e.g., computing device 006 of FIG. 1. FIG. 9 illustrates a gallery view 900 containing a history of videos 910 taken by the user. This can allow the user to view videos over time and view progress in swing/movement improvement. Selecting the add button 920 can take a user to add interface 1000 shown in FIG. 10. Add interface 1000 can give the user options 1010 for adding/uploading/taking new videos.

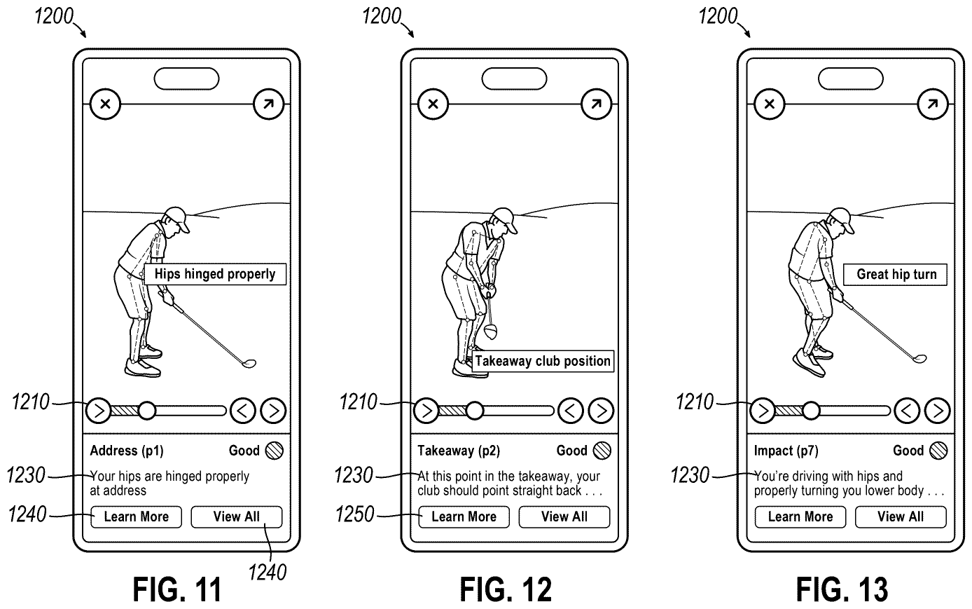

Selecting a video 910 from gallery view 900 can take a user to video interface 1200 shown in FIGS. 11-13. Timeline 1210 can allow a user to pause the video during different parts of the swing or movement. Feedback panel 1230 can provide feedback at each position within the swing (e.g., address P1 and impact P7) and provide directions or guidance on how to improve said position.

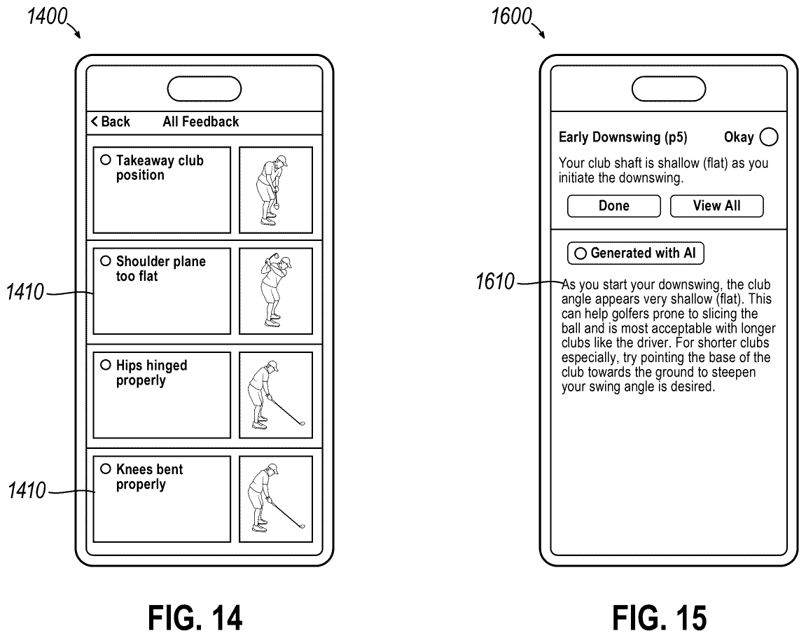

Selecting view all 1240 within video interface 1200 can allow a user to view all feedback in the video, such as shown in all feedback UI 1400 of FIG. 14. Within all feedback UI 1400 a user can see a list of specific feedback 1410 on different parts of the swing or movement. Different specific feedback 1410 can be colored or identified differently to show which portions of the swing/movement are good or need more work.

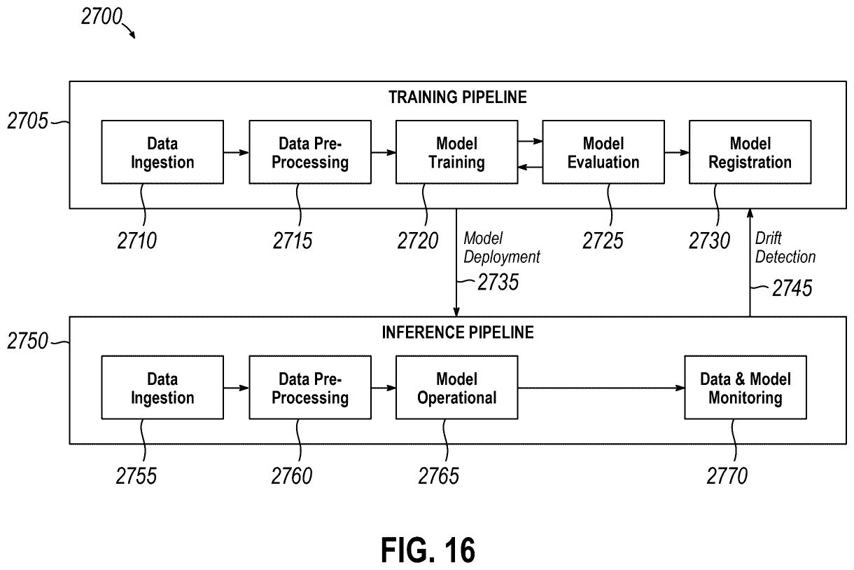

Selecting learn more 1250 within video interface 1200, or selecting a specific feedback 1410 of feedback UI 1400, can allow a user to view more detailed feedback, such as in detail UI 1600 of FIG. 16. Detailed feedback 1610 can present more detail than in feedback panel 1230 of FIGS. 11-13. Feedback shown in FIGS. 11-15 can be generated by LLMs, generative AI, a memory that stores specific feedback related to certain measurements from method 800, or other means, or combinations of the foregoing.

### AI/ML Versions

Various versions under the present disclosure can incorporate AI/ML functionality. For example, for purposes of the present disclosure, server 008, computing device 006, local memory 010, and/or network 012 of FIG. 1 can be said to comprise an AI/ML engine, either separately or together. Each component may comprise a separate instance of an identical AI/ML engine. Or a “central” AI/ML engine could be running at any location, such as server 008, and others of the foregoing devices could function like an output/input interface to the central AI/ML engine, allowing user input, data collection, user interface for a user, etc. As described above, server 008 may collect data from swing videos, swing video history, or other resources; receive data from users; track swing video data; receive data from third parties such as hardware peripherals or other third parties; or otherwise receive or utilize a variety of other data. This data can be used to analyze swings, swing issues over time, user skill level, determine cause-and-effect relationships between biomechanics and sports results, etc. This data can also be used to train AI/ML engine or can be analyzed by a previously trained AI/ML engine.

It should be understood that AI/ML engine can comprise one or more AI/ML engines. Commonly the terms machine learning engine or machine learning algorithm are used to refer to a specific algorithm. The term artificial intelligence commonly is used to refer to an entire system that achieves intelligence-like outcomes while using multiple sub-systems, such as multiple machine learning algorithms. But both ML and AI have been used to identify a variety of functionalities or types of systems that utilize various combinations of specific ML algorithms. As used herein, AI/ML engine is intended to denote a variety of AI/ML functionalities that fall under the category of AI or ML algorithms and systems that utilize such functionalities. Examples of AI/ML engine can comprise any one or more of e.g.: supervised learning, reinforcement learning, natural language processing such as LLMs, neural networks, computer vision, facial recognition, chatbots, virtual assistants, unsupervised learning, generative AI, other AI or ML models, and/or combinations of any of the foregoing.

In system 002 of FIG. 1, multiple AI/ML engines can be used. For example, one AI/ML engine can comprise an LLM-based chatbot that interacts with any user to gauge swing improvement wants and needs, receive requests or perform other tasks. It may be that multiple different LLMs are used. For example, one LLM might be trained on downswing elements, backswing elements, or other swing elements or types of swings. A different AI/ML engine may be stored or implemented at various of the components shown in FIG. 1. Alternatively, there may be a smaller number of AI/ML engines, and various of the components of FIG. 1 may function as user interfaces for a remote or local AI/ML engine stored at e.g., server 008. Data used to train, retrain, or implement any of AI/ML engines may be stored at any one or more of the components shown in FIG. 1. A person of ordinary skill in the art will recognize that a variety of such variations are possible under the present disclosure.

The architecture of an AI/ML engine (e.g., structure, number of layers, nodes per layer, activation function etc.) may need to be tailored for each particular use case. For example, properties to vary can include e.g.: user characteristic (race, sex, age, etc.), swing types, swing elements, ideal swing data, and a variety of other factors. These may all need to be considered when designing an AI/ML engine architecture.

Building an AI/ML engine can include several development steps where the actual training of a ML model or algorithm is just one step in a training pipeline. An important part in AI/ML development is AI/ML model lifecycle management. One version of a model lifecycle management procedure 2700 is illustrated in FIG. 16. The model lifecycle management can in some versions comprise two pipelines: a training pipeline 2705 and an inference pipeline 2750.

At 2710 in the training pipeline 2705, data ingestion 2710 occurs, which includes gathering raw (training) data from a data storage. After data ingestion 2710, there may also be a step that controls the validity of the gathered data. At 2715 data pre-processing occurs, which can include feature engineering applied to the gathered data. This may involve, e.g., data normalization or data formatting or transformation required for the input data to the AI/ML model. After the ML model's architecture is fixed, it should be trained on one or more datasets. At 2720 model training is performed in which the AI/ML model is trained with the raw training data. To achieve good performance during live operation in a system (the so-called inference phase), the training datasets should be representative of actual data the ML model will encounter during live operation. The training process often involves numerically tuning the ML model's trainable parameters (e.g., the weights and biases of the underlying neural network (NN)) to minimize a loss function on the training datasets. The loss function may be, for example, based on maximizing swing improvement; minimizing swing variation; minimizing swing difficulty, or other metrics. The purpose of the loss function is to meaningfully quantify the reconstruction error for the particular use case at hand. At 2725 model evaluation can be performed where the performance is benchmarked to some baseline. Model training 2720 and evaluation 2725 can be iterated until an acceptable level of performance is achieved. At 2730 model registration occurs, in which the AI/ML model is registered with any corresponding data on how the AI/ML model was developed, and e.g., AI/ML model evaluation data. At 2735 model deployment occurs, wherein the trained/re-trained AI/ML model (e.g., an AI/ML engine in a component of FIG. 1) is implemented in the inference pipeline 2750.

Data ingestion 2755 in the inference pipeline 2750 refers to gathering raw (inference) data from a data source. Data pre-processing 2760 can be essentially identical/similar to the data pre-processing 2715 of the training pipeline 2705. At 2765, the operational model received from the training pipeline 2705 is used to process new data received during operation of e.g., system 002 of FIG. 1 or components thereof. At 2770 data and model monitoring is performed. Here the inference data is analyzed to determine whether the inference data are from a distribution that aligns with the training data, as well as monitoring model outputs for detecting any performance, or operational, variance or drifts. The variance or drift is used at 2745 (drift detection) to update the AI/ML model registration.

The training process is typically based on some variant of a gradient descent algorithm, which, at its core, typically comprises three components: a feedforward step, a back propagation step, and a parameter optimization step. These steps can be described using a dense ML model (i.e., a dense NN with a bottleneck layer) as an example.

Feedforward: A batch of training data, such as a mini-batch, (e.g., several downlink-channel estimates) is pushed through the ML model, from the input to the output. The loss function is used to compute the reconstruction loss for all training samples in the batch. The reconstruction loss may be an average reconstruction loss for all training samples in the batch.

Back propagation (BP): The gradients (partial derivatives of the loss function, L, with respect to each trainable parameter in the ML model) are computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n+1.

Parameter optimization: The gradients computed in the back propagation step are used to update the ML model's trainable parameters. An approach is to use the gradient descent method with a learning rate hyperparameter (a) that scales the gradients of the weights and biases. It is preferred to make small adjustments to each parameter with the aim of reducing the average loss over the (mini) batch. It is common to use special optimizers to update the ML model's trainable parameters using gradient information. The following optimizers are widely used to reduce training time and improving overall performance: adaptive sub-gradient methods (AdaGrad), RMSProp, and adaptive moment estimation (ADAM).

The above process (feedforward, back propagation, parameter optimization) can be repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined value chosen by a user.

In some implementations, a function F(·) may be generated by a ML process, such as, for example, supervised learning, reinforcement learning, and/or unsupervised learning. It should further be understood that supervised learning may be done in various ways, such as, for example, using random forests, support vector machines, neural networks, transformers, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware described in system 002 of FIG. 1 (e.g., in the form of simple vector-matrix multiplications).

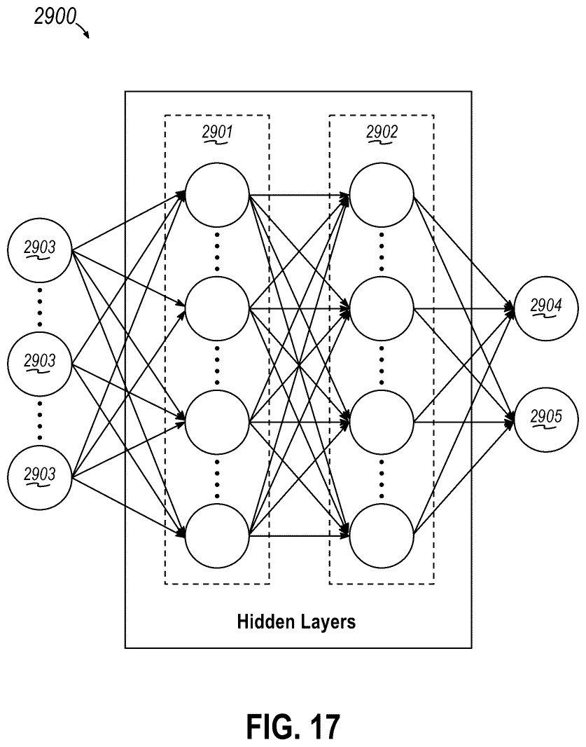

Referring now to FIG. 17, an example NN 2900 (e.g., DNN) is shown. In some implementations, and as shown, the neural network 2900 may include two hidden layers represented by dashed boxes 2901 and 2902. In one implementation, the inputs 2903 may be fed into the NN 2900. Next, the inputs 2403 may go through a set of hidden layers (e.g., 2901 and/or 2902). Once the inputs 2903 pass though the hidden layers 2901 and/or 2902, they may be output (e.g., as an output layer) as outputs 2904, 2905. Outputs 2904, 2905 could be, e.g., swing feedback; customized tips, descriptions, explanations, or other customized feedback; image, video, or animated potential swings; recommended drills or other suggestions for improvements; comparisons to other users' swings; or another output valuable. Possible inputs can include e.g.: swing video or image, swing data, user skill level, equipment data, or other variables, or other variables. User skill level may include, for example, a GHIN (Golf Handicap Information Network) handicap score in golf, a batting average in baseball, a USTA (United States Tennis Association) ranking, or other sports skill tracking system. In some versions, the user skill level may be used to track results of swing changes in overall performance.

As should be understood by one of ordinary skill in the art, in order for the NN 2900 to output a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

### Additional Versions

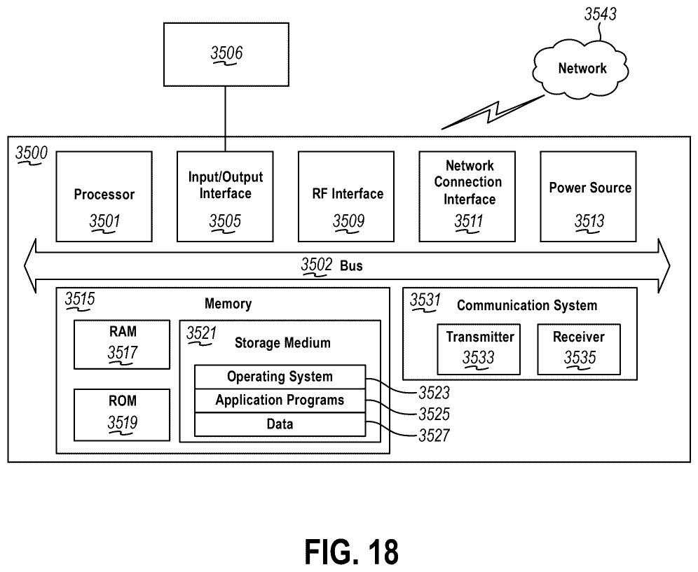

FIG. 18 illustrates a version of various computing devices within system 002 of FIG. 1, or components thereof e.g., computing device 006, server 008, local memory 010, which can comprise e.g., computers, tablets, servers, databases, mobile devices, or other computing or smart devices described herein. FIG. 18 shows a schematic block diagram of a computing device 006 (or components thereof) according to certain versions of the present disclosure. System 3500 can be used to analyze and/or optimize: the functionalities described with respect to system 002 of FIG. 1 and its components, or to perform other methods, such AI or ML-related tasks and analyses as described herein.

Computing device 3500 includes processor 3501 that is operatively coupled via a bus 3502 to an input/output interface 3505, a power source 3513, a memory 3515, a RF interface 3509, network communication interface 3511, and/or any other component, or any combination thereof. The level of integration between the components may vary from one version to another. Further, certain computing devices 3500 (or components thereof) may contain multiple instances of a component, such as multiple processors, memories, transceivers, transmitters, receivers, etc.

The processor 3501 is configured to process instructions and data and may be configured to implement any sequential state machine operative to execute instructions stored as machine-readable computer programs in memory 3515. Processor 3501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 3501 may include multiple central processing units (CPUs).

In the example, input/output interface 3505 may be configured to provide an interface or interfaces to an input/output device(s) 3506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 3500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some versions, the power source 3513 is structured as a battery or battery pack. Other types of power sources, such as an external power source (e.g., an electricity outlet), photovoltaic device, or power cell, may be used. The power source 3513 may further include power circuitry for delivering power from the power source 3513 itself, and/or an external power source, to the various parts of computing device 3500 via input circuitry or an interface such as an electrical power cable.

Memory 3515 may be configured to include memory such as random-access memory (RAM) 3517, read-only memory (ROM) 3519, programmable read-only memory (PROM), erasable programmable read-only memory (EPROM), electrically erasable programmable read-only memory (EEPROM), magnetic disks, optical disks, hard disks, removable cartridges, flash drives, other storage medium 3521, and so forth. In one example, the memory 3515 includes one or more application programs 3525, an operating system 3523, web browser application, a widget, gadget engine, or other application, and corresponding data 3527. Memory 3515 may store, for use by the computing device 3500, any of a variety of various operating systems or combinations of operating systems. An article of manufacture, such as one including a simulation system or communication system may be tangibly embodied as or in memory 2515, which may be or comprise a device-readable storage medium.

Processor 3501 may be configured to communicate with an access network or other network using the RF interface 3509 or network connection interface 3511. The RF interface 3509 or network connection interface 3511 may comprise one or more communication subsystems and may include or be communicatively coupled to an antenna. In the illustrated version, communication functions of the RF interface 3509 or network connection interface 3511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

System 002 of FIG. 1, or computing devices 3500 as described above or in regard to FIG. 1, can perform a variety of method versions under the present disclosure. Several example method versions are given below but these examples are non-limiting and are only meant to illustrate certain versions.

Although the computing devices described herein (e.g., servers, computing devices, etc. of system 002 of FIG. 1 may include the illustrated combination of hardware components, other versions may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in e.g., one of the components of FIG. 1, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain versions, some or all of the functionality described herein may be provided by processing circuitry executing instructions stored on in memory, which in certain versions may be a computer program product in the form of a non-transitory computer-readable storage medium. In alternative versions, some or all of the functionality may be provided by the processing circuitry without executing instructions stored on a separate or discrete device-readable storage medium, such as in a hard-wired manner. In any of those particular versions, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system- or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary versions may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary versions of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some versions a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more versions or implementations, which are exemplary in nature. As used herein, the term “exemplary” means “serving as an example, instance, or illustration,” and should not necessarily be construed as preferred or advantageous over other versions disclosed herein. In addition, reference to an “implementation” of the present disclosure or versions includes a specific reference to one or more versions thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one version,” “an version,” “an example version,” and the like indicate that the version described may include a particular feature, structure, or characteristic, but it is not necessary that every version includes the particular feature, structure, or characteristic. Moreover, such phrases are not necessarily referring to the same version. Further, when a particular feature, structure, or characteristic is described in connection with an version, it is submitted that it is within the knowledge of one skilled in the art to affect such feature, structure, or characteristic in connection with other versions whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example versions. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary versions of this disclosure may become apparent to those skilled in the relevant arts in view of the foregoing description, when read in conjunction with the accompanying drawings. However, any and all modifications will still fall within the scope of the non-limiting and exemplary versions of this disclosure.

It is understood that for any given component or version described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain versions, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain versions of the present disclosure may include, incorporate, or otherwise comprise properties or features (e.g., components, members, elements, parts, and/or portions) described in other versions disclosed and/or described herein. Accordingly, the various features of certain versions can be compatible with, combined with, included in, and/or incorporated into other versions of the present disclosure. Thus, disclosure of certain features relative to a specific version of the present disclosure should not be construed as limiting application or inclusion of said features to the specific version. Rather, it will be appreciated that other versions can also include said features, members, elements, parts, and/or portions without necessarily departing from the scope of the present disclosure.

Moreover, unless a feature is described as requiring another feature in combination therewith, any feature herein may be combined with any other feature of a same or different version disclosed herein. Furthermore, various well-known aspects of illustrative systems, methods, apparatus, and the like are not described herein in particular detail in order to avoid obscuring aspects of the example versions. Such aspects are, however, also contemplated herein.

It will be apparent to one of ordinary skill in the art that methods, devices, device elements, materials, procedures, and techniques other than those specifically described herein can be applied to the practice of the described versions as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described d versions are examples only. Alterations, modifications, and variations may be affected to the particular versions by those of skill in the art without departing from the scope of the description, which is defined solely by the appended claims.

What is claimed is:

1. A method performed by a two-dimensional video swing analysis system, comprising:
continuously capturing a video of a swing session via a camera;
identifying one or more swing occurrences based on one or more motion characteristics;
for each of the one or more swing occurrences:
retaining a portion of frames preceding and following the swing occurrence;
assembling the retained portion of frames and one or more frames during the swing occurrence as a clip;
splicing the clip into a plurality of image frames;
determining the most likely swing position in the plurality of image frames;
determining key swing position data based on the most likely swing position; and
producing a rating for one or more elements of the swing occurrence based on the key swing position data.

2. The method of claim 1, wherein continuously capturing the video comprises writing incoming frames to a circular buffer in volatile memory with head and tail pointers that advance as new frames arrive.

3. The method of claim 1, wherein identifying one or more swing occurrences comprises monitoring a sliding window of consecutive frames.

4. The method of claim 1, further comprising materializing the clip upon completion after producing the rating for the one or more elements of the swing occurrence; and wherein retaining the portion of frames preceding and following the swing occurrence comprises retaining the portion of frames by reference.

5. The method of claim 1, wherein assembling the retained portion of frames and one or more frames during the swing occurrence comprises batching the retained portion of frames and one or more frames during the swing occurrence into one or more micro-batches sized based on available compute.

6. The method of claim 1, wherein determining the most likely swing position in the plurality of image frames comprises enforcing proper ordering of swing positions.

7. The method of claim 1, further comprising streaming a plurality of raw image frames to a preview interface in parallel.

8. The method of claim 1, wherein identifying one or more swing occurrences comprises classifying each swing occurrence based on swing data.

9. The method of claim 8, wherein the swing data comprises at least one of: one or more pose trajectories, club-tip motion smoothing, or audio amplitude spikes aligned to frame timestamps.

10. A two-dimensional video swing analysis system, comprising:
a processor; and
a memory storing instructions whereby the processor is configured to perform the steps of:
continuously capture a video of a swing session via a camera;
identify one or more swing occurrences based on one or more motion characteristics;
for each of the one or more swing occurrences:
retain a portion of frames preceding and following the swing occurrence;
assemble the retained portion of frames and one or more frames during the swing occurrence as a clip;
splice the clip into a plurality of image frames;
determine the most likely swing position in the plurality of image frames;
determine key swing position data based on the most likely swing position; and
produce a rating for one or more elements of the swing occurrence based on the key swing position data.

11. The system of claim 10, wherein continuously capturing the video comprises writing incoming frames to a circular buffer in volatile memory with head and tail pointers that advance as new frames arrive.

12. The system of claim 10, wherein identifying one or more swing occurrences comprises monitoring a sliding window of consecutive frames.

13. The system of claim 10, wherein retaining the portion of frames preceding and following the swing occurrence comprises retaining the portion of frames by reference; and the processor is further configured to perform the step of: materializing the clip upon completion after producing the rating for the one or more elements of the swing occurrence.

14. The system of claim 10, wherein assembling the retained portion of frames and one or more frames during the swing occurrence comprises batching the retained portion of frames and one or more frames during the swing occurrence into one or more micro-batches sized based on available compute.

15. The system of claim 10, wherein determining the most likely swing position in the plurality of image frames comprises enforcing proper ordering of swing positions.

16. The system of claim 10, wherein the processor is further configured to perform the step of:
streaming a plurality of raw image frames to a preview interface in parallel.

17. The system of claim 10, wherein identifying one or more swing occurrences further comprises classifying each swing occurrence based on swing data.

18. The system of claim 17, wherein the swing data comprises at least one of: one or more pose trajectories, club-tip motion smoothing, or audio amplitude spikes aligned to frame timestamps.

19. A two-dimensional video swing analysis system, comprising:
a processor; and
a memory storing instructions whereby the processor is configured to perform the steps of:
receive, from a user, one or more videos of a swing occurrence;
splice the one or more videos into one or more image frames;
determine the most likely swing position in the one or more image frames;
determine key swing position data based on the most likely swing position; and
produce a rating for one or more elements of the swing occurrence based on the key swing position data.

20. The system of claim 19, wherein the processor is further configured to perform the step of:
generate one or more drill recommendations.
